(19) United States
(12) Patent Application Publication
(10) Pub. No.: US 2025/0155783 A1
(43) Pub. Date: May 15, 2025

(54) POLARIMETRIC CAMERA

(71) Applicant: COMMISSARIAT À L'ENERGIE ATOMIQUE ET AUX ENERGIES ALTERNATIVES, Paris (FR)

(72) Inventor: Jérôme VAILLANT, Grenoble Cedex 09 (FR)

(73) Assignee: COMMISSARIAT À L'ENERGIE ATOMIQUE ET AUX ENERGIES ALTERNATIVES, Paris (FR)

(21) Appl. No.: 18/936,248

(22) Filed: Nov. 4, 2024

(30) Foreign Application Priority Data
Nov. 13, 2023 (FR) 2312380

(51) Int. Cl. G03B 15/00; G02B 27/28; H04N 23/55

(52) U.S. Cl. CPC G03B 15/00; G02B 27/283; G02B 27/288; H04N 23/55

(57) ABSTRACT

A polarimetric camera includes an optical system and an image sensor. The optical system (i) forms, on the image sensor, N images of a scene to be imaged, with N greater than or equal to 2, N being a number of polarization states, (ii) includes a polarization separator diverting the light beams coming from the scene according to the N polarization states, and (iii) has N exit pupils. The image sensor includes a plurality of detection pixels distributed in N subsets of pixels. Each subset is associated with an exit pupil and receives the incident light beams according to the polarization state of the associated exit pupil. The image sensor includes at least N angular filters, each angular filter transmitting, to a subset of pixels, the light beams coming from the associated exit pupil, and filtering the other light beams.

### TECHNICAL FIELD

The present invention relates in general terms to imaging systems, and relates more particularly to so-called polarimetric cameras, adapted to record, for a given scene, information relating to the polarization of the captured light.

### PRIOR ART

Measuring information on the polarization of light when an image is acquired can be advantageous for numerous applications. It makes it possible in particular to implement treatments for improving images, adapted according to the application in question. For example, it makes it possible to attenuate or on the contrary to exacerbate reflections on an image of any surface causing a specular reflection, such as a window, water or the surface of an eye. It furthermore makes it possible to detect manufactured objects in a natural environment, these generally having a polarization signature. Among the applications that can derive benefit from measuring polarization information, mention can also be made of industrial control applications, biomedical applications, for example applications for detecting cancerous cells (the latter polarizing light through their fibrous nature), contrast improvement applications for capturing images in a diffusing environment (fog, undersea imaging, etc), or remote mapping applications or applications for acquiring depth images, wherein polarization can supply information on the orientation of the surface of the manufactured objects, and thus, aid 3D reconstruction in addition to another modality such as active illumination by structured light or by measuring time of flight.

To extract the relevant information for a given scene by means of a polarimetric camera, a combination of various polarization states is necessary. For this purpose, the polarimetric camera (which conventionally includes an optical system and an image sensor) must be able to acquire these various polarization states simultaneously and with the same viewpoint so that the images can be strictly superimposable. The polarizations are therefore separated actually at the polarimetric camera. Two configurations are possible.

In a first configuration, the separation of the polarizations occurs at the image sensor of the polarimetric camera. The image sensor, having a matrix of detection pixels, is then configured so that each of its pixels is sensitive only to a single polarization state, for example by means of polarizing filters. The pixels sensitive to different polarization states are interlaced in an elementary pattern. For this configuration, the optical system used is a standard optical system and a single image is formed thereby on the image sensor.

One of the limitations of this first configuration relates to the interlacing of these pixels. This involves producing polarizing filters to the scale of the pixel, and therefore of very reduced size, which leads to a reduction in its performances. Another limitation lies in the fact that, the pixels sensitive to different polarization states being adjacent in the pixel matrix, polarization crosstalk may appear on the images.

In a second configuration, the separation of the polarizations this time occurs at the optical system of the polarimetric camera. In this configuration, the optical system is configured to form, on the image sensor, one image per polarization state, each image being spatially offset with respect to the others. The optical system for this purpose includes, for example, a polarization separator (also called a polarization router). For this configuration, the image sensor used is a standard image sensor.

The articles “Imaging polarimetry through metasurface polarization gratings” by Rubin et al., Optics Express, March 2022, vol. 30, no 6, p. 9389-9412, and “Matrix Fourier optics enables a compact full-Stokes polarization camera” by Rubin et al., Science 365, 2019, eaax1839 DOI: 10.1126/science.aax1839, describe the production of polarization separators of the metasurface type to be placed in the optical system, these metasurfaces making it possible to form, on the image sensor, four images corresponding to four different polarization states.

One of the limitations of this second configuration relates to the overlapping of the images. An image corresponding to one polarization state will, at least partly, overlap the image corresponding to another polarization state. It is possible to use a vignetting screen to limit this overlapping, however this solution results in reducing the brightness on the edges of the image.

Another limitation related to the use of metasurfaces is the presence, around the optical axis of the optical system, of a non-polarized image corresponding to the zero order diffraction of these metasurfaces. Although these metasurfaces are configured to limit the intensity of this zero-order image, it is however not possible to eliminate it completely.

### DESCRIPTION OF THE INVENTION

The present invention aims to at least partly remedy the drawbacks of the solutions proposed by the prior art, in particular those disclosed above.

For this purpose, the object of the invention is a polarimetric camera including an optical system and an image sensor:
the optical system, having a principal optical axis, being adapted to form, on the image sensor, at least N spatially distinct images of a scene to be imaged, at the rate of one image per polarization state, with N greater than or equal to 2, N being a predefined number of polarization states, and including:
   a polarization separator adapted to divert the incident light beams coming from the scene to be imaged according to the N polarization states, the optical system then having at least N exit pupils at least partly offset in pairs orthogonally to the principal optical axis;
the image sensor including a plurality of detection pixels each comprising a photodetector,
   the detection pixels being distributed in at least N subsets of pixels, each associated with an exit pupil, and each intended to receive the incident light beams according to the polarization state of the associated exit pupil.

According to the invention, the image sensor includes at least N angular filters located between the optical system and the photodetectors, each angular filter being adapted to transmit, to a subset of pixels, the incident light beams coming from the associated exit pupil, and to at least partly filter the incident light beams coming from the other exit pupil or pupils.

Such a polarimetric camera advantageously improves the quality of the N images associated with the N images associated with the N polarization states, in particular by virtue of the filtering, by the angular filters, of at least some of the parasitic light beams that are not associated with the required polarization state.

In addition, such a polarimetric camera advantageously makes it possible, by virtue of the association of the angular filters with the polarization separator, to use a standard image sensor.

According to particular embodiments, the polarimetric camera can include the following features, implemented separately or in each of the technically operative combinations thereof.

According to particular embodiments, the pixels of a subset of pixels are adjacent.

According to particular embodiments, the N angular filters are disposed so as to be coplanar.

According to particular embodiments, the N angular filters are formed in one and the same grid having openings sized to transmit, to a subset of pixels, the incident light beams coming from the associated exit pupil, and to at least partly filter the incident light beams coming from the other exit pupil or pupils.

According to particular embodiments, the grid is opaque.

According to particular embodiments, the image sensor includes a plurality of microlenses, adapted to focus the incident light beams on the photodetectors of the detection pixels, located between the optical system and the angular filters.

According to particular embodiments, the polarization separator is a bidimensional metasurface.

According to particular embodiments, the image sensor includes N polarizing filters located between the optical system and the angular filters, adapted to transmit, to a subset of pixels, the incident light beams coming from the associated exit pupil and having the associated polarization state, and to at least partly filter the incident light beams coming from the other exit pupils and therefore having other polarization states.

According to particular embodiments, the N polarizing filters are disposed so as to be coplanar.

According to particular embodiments, the N polarizing filters (340) are produced in the same metal structure.

### BRIEF DESCRIPTION OF THE DRAWINGS

Other aspects, aims, advantages and features of the invention will become more apparent upon reading the following detailed description of preferred embodiments thereof, given as a non-limiting example, and made with reference to the appended drawings, wherein:

FIG. 1 is a schematic partial view, in perspective and exploded, of an example of a polarimetric camera according to one embodiment;

FIG. 2A is an example of an optical diagram of a polarimetric camera that does not include an angular filter at the detection pixels;

FIG. 2B is an optical diagram of a polarimetric camera according to one embodiment;

FIG. 3A illustrates an example of angular response of a detection pixel that is not associated with an angular filter, and the angular response of a detection pixel associated with an angular filter according to one embodiment;

FIG. 3B is a schematic partial view, in cross section, of a detection pixel of an image sensor of the polarimetric camera according to one embodiment.

### DETAILED DESCRIPTION OF PARTICULAR EMBODIMENTS

In the figures and in the remainder of the description, the same references represent identical or similar elements. In addition, the various elements are not shown to scale so as to promote clarity of the figures. Moreover, the different embodiments and variants are not mutually exclusive and can be combined together. Unless indicated otherwise, the terms “substantially”, “about”, “of the order of” mean within a 10% margin, and preferably within a 5% margin. Moreover, the terms “included between . . . and . . . ” and the like mean that the bounds are included, unless stated otherwise.

For reasons of clarity, only the steps and elements useful to an understanding of the embodiments described have been shown and are detailed. In particular, the photodetectors and the electronic control circuits of the image sensors of the polarimetric cameras described have not been detailed, the embodiments described being compatible with the usual implementations of these elements.

In addition, when reference is made to qualifications of absolute position, such as the terms “top”, “bottom”, “left”, “right”, etc, or relative position, such as the terms “above”, “below”, “upper”, “lower”, etc, or to orientation qualifications, such as the terms “horizontal”, “vertical”, etc, reference is made, unless stated to the contrary, to the orientation in the figures.

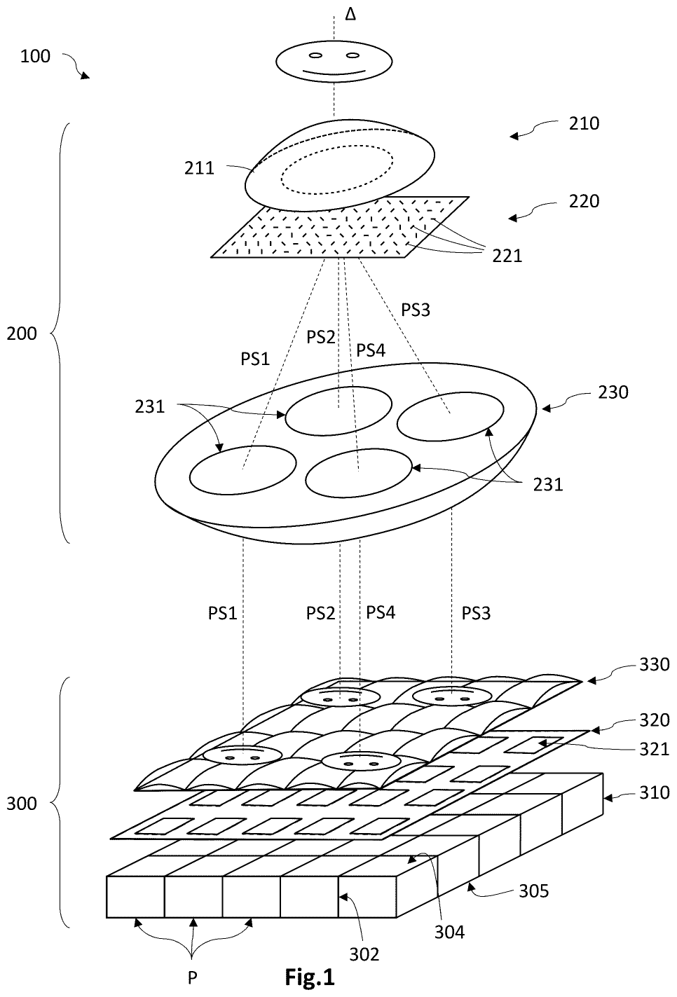

FIG. 1 illustrates a schematic partial view, in perspective, of a polarimetric camera 100 according to an example embodiment of the invention. The polarimetric camera 100 includes at a minimum:
an optical system 200, adapted to form, on an image sensor 300, at least N spatially distinct images of a scene to be imaged, at the rate of one image per polarization state, with N greater than or equal to 2, N being a predefined number of polarization states, and having at least N exit pupils 231, one per polarization state, at least partly offset in pairs orthogonally to a principal optical axis 4;
an image sensor 300, including a plurality of detection pixels P, which are distributed in at least N subsets of pixels, each associated with an exit pupil 231, and each intended to receive the incident light beams according to the state of polarization of the associated exit pupil.

The optical system 200 includes a polarization separator 220, adapted to separate the incident light beam coming from the scene to be imaged according to the N predefined polarization states. N is at least equal to 2 (at least 2 separate polarization states), but may be equal to 3, to 4 or even to more. The optical system 200 preferably includes a collimation optic 210 located upstream of the polarization separator 220, and an imaging optic 230 located downstream of the polarization separator 220.

Spatially distinct image means that the N images formed in the image plane of the optical system 200 are not completely superimposed in pairs in the image plane, but they are at least partly offset in pairs in the image plane, and preferably completely offset (without overlap) in the image plane. Thus, the exit pupils 231 are at least partly offset in pairs orthogonally to the principal optical axis Δ, and preferably completely offset (without overlap) orthogonally to the principal optical axis Δ.

According to the invention, the image sensor 300 includes at least N angular filters 320 located between the optical system 200 and the photodetectors 303 of the image sensor 300, each angular filter 320 being adapted to transmit, to a subset of pixels, the incident light beams coming from the associated exit pupil 231, and to at least partly filter the incident light beams coming from the other exit pupil or pupils 231.

Preferably, the optical system 200 includes a collimation optic 210. Said collimation optic is disposed, on the principal optical axis Δ, upstream of the polarization separator 220, in the direction of propagation of the incident light beams, preferably perpendicularly to the principal optical axis Δ.

The collimation optic 210, for example a lens, is adapted to collect the incident light beams coming from the scene to be imaged and to collimate them towards the polarization separator 220. Thus, the incident light beams arriving on the polarization separator 220 are parallel to each other.

The use of such a collimation optic 210, upstream of the polarization separator 220, makes it possible to optimise the operation of the polarization separator 220, in particular when it is a case of a bidimensional metasurface. In such a case, the polarization separator 220 (metasurface) is located in the plane of the entry pupil 211. Thus, all the light rays coming from the scene path through the entry pupil and cover the entire metasurface. A metasurface with a minimum size, the design of which is simplified, is therefore produced. In the case where the metasurface is located upstream or downstream of the entry pupil 211, a larger metasurface is then necessary and the design thereof may be more complex.

The collimation optic 210 here defines an entry pupil 211 of the optical system 200. Entry pupil means an image of the aperture diaphragm of the optical system 200, seen from the side of the scene to be imaged. It may be a case here of the opaque rim of the lens 210.

It should be noted that, in the case of a more complex optical system 200, the latter may include diaphragms disposed to create an entry pupil 211 in an accessible plane to place therein the polarization separator 220, and to create an exit pupil plane that makes it possible to spatially separate the exit pupils 231 from one another. It should be noted that the polarization separator 220 (metasurface) may be one of these diaphragms.

The polarization separator 220 is disposed on the principal optical axis Δ of the optical system 200, preferably perpendicularly to the principal optical axis Δ. It uses an optical routing (sorting) polarization function, i.e. a function of diverting the incident light beams according to their polarization state, the light beams then here being transmitted to the imaging optic 230.

In other words, the polarization separator 220 is configured to separate the incident light beams according to their polarization state and to direct them to spatially distinct zones of the imaging optic 230, as illustrated on FIG. 1. These spatially distinct zones, here of the imaging optic 230, define here the exit pupils 231 of the optical system 200. As indicated previously, the exit pupils 231 are therefore at least partly offset in pairs orthogonally to the principal optical axis Δ.

It should be noted that the exit pupils 231 can obviously be located otherwise than in the imaging optic 230, in particular when the optical system 200 is a more complex optical system than two lenses. In this case, the exit pupils 231 can then be located upstream of the imaging optic 230, and the entry pupil 211 can be not coincident with the lens 210.

Exit pupil means an image of the aperture diaphragm of the optical system 200 seen from the side of the image sensor 300. It is a case of a spatially delimited zone through which the light passes to reach the image sensor 300.

In this embodiment, N is equal to 4. Thus, the polarization separator 220 is adapted to route the incident light beams according to four different polarization states, denoted: PS1, PS2, PS3, PS4. There are thus at least 4 exit pupils 231, each exit pupil 231 being arranged to receive incident light beams according to one of the four polarization states PS1, PS2, PS3, PS4.

For example, the polarization separator 220 is adapted to divert the incident light beams according to four different polarization orientations, for example linear polarizations in respectively four directions forming respectively angles of 0°, 90°, +45°, −45° with respect to a reference direction.

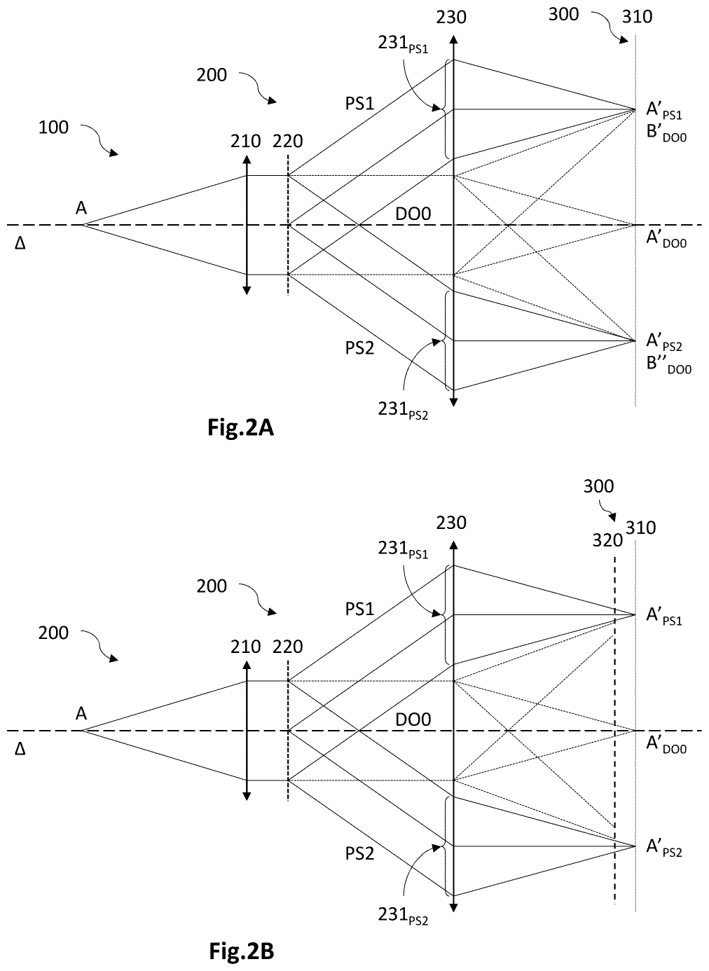

In the case where the polarization separator 220 is a bidimensional metasurface, the optical system 200 can include a 5^{th} exit pupil 231, which is associated with the zero order diffraction of the metasurface. This exit pupil is not illustrated on FIG. 1, but is shown on FIG. 2A and FIG. 2B. The image of the object point A (located on the principal optical axis Δ) is denoted A′_{DO0} (DO0 standing for Diffraction Order 0) and is also located on the principal optical axis Δ.

As described above, in a preferred example embodiment, the polarization separator 220 is a bidimensional metasurface, as illustrated on FIGS. 1, 2A and 2B. The bidimensional metasurface comprises a bidimensional lattice of portions 221 of a first material, surrounded laterally by a filling material with a different refractive index. Preferably, the first material has a refractive index higher than that of the filling material. The portions 221 of the bidimensional metasurface have sub-wavelength lateral dimensions, i.e. the largest lateral dimension of each portion 221 is smaller than the principal wavelength intended to be measured by the underlying detection pixel P (for example the wavelength for which the quantum efficiency of the pixel P is maximum). For example, for pixels P intended to measure visible or near infrared radiations, for example radiations with a wavelength of less than 1 μm, the largest dimension of each portion is between 10 nm and 500 nm (here, half of the maximum wavelength of the detection spectral band, here 1 μm), for example between 80 nm and 300 nm.

The portions 221 of the bidimensional metasurface 220 preferentially have varied lateral dimensions. The sizing and the arrangement of the portions 221 are defined according to the optical function sought. Thus, to implement the polarization routing function, portions 221 can be provided having, in plan view, asymmetric shapes, for example rectangular or elliptical, on the understanding that the portions 221 can have, in plan view, any shape. The portions 221 can have vertical sides, oblique sides or sides in staircase form, comprising at least one step. Moreover, each portion 221 can consist of a single material or a stack of layers of different materials. The pattern of the bidimensional metasurface can be defined by means of an electromagnetic simulation tool, for example using inverse design methods, example of the type described in the article entitled “Phase-to-pattern inverse design paradigm for fast realization of functional metasurfaces via transfer learning” by Zhu, R., Qiu, T., Wang, J. et al. Nat. Commun. 12, 2974 (2021), or in the article entitled “Matrix Fourier optics enables a compact full-Stokes polarization camera” by Rubin et al., SCIENCE, Vol. 365, Issue 6448-5 Jul. 2019.

The portions 221 of the bidimensional metasurface preferably all have the same height, for example of the same order of magnitude as the principal wavelength intended to be measured by each detection pixel P, for example between 20 nm and 2 μm, preferably between 100 nm and 1000 nm, for wavelength radiations of less than 1 μm. Using portions 221 of constant height makes it possible to simplify the manufacture of the bidimensional metasurface.

In the example illustrated in FIG. 1, the polarization separator 220 comprises a single bidimensional metasurface. By way of variant, the polarization separator of the optical system could comprise a plurality of bidimensional metasurfaces, disposed or not in a coplanar manner.

In another example embodiment of the polarization separator, said polarization separator may be a Wollaston prism. The Wollaston prism is adapted to separate the incident light beams into 2 orthogonal polarization states. The Wollaston prism is generally formed by two prisms made from touching birefringent materials, for example made from calcite or quartz, the optical axes of which are orthogonal to each other. The advantage of using a Wollaston prism is the absence of a zero order diffraction and therefore the absence, around the optical axis of the optical system, of a non-polarized image corresponding to this zero order diffraction.

The polarization separator 220 can comprise a single Wollaston prism. By way of variant, the polarization separator 220 of the optical system 200 can comprise a plurality of Wollaston prisons, each prism separating the incident light beams according to 2 different orthogonal polarization states.

In a preferred embodiment, in particular illustrated on the figures, the imaging optic 230 is a focusing lens, adapted to focus the incident light beams on the plane of the image sensor 300. The imaging optic 230 is configured firstly to receive the incident light beams distributed spatially according to their polarization state and secondly to focus the incident light beams according to the N polarization states on the corresponding N zones of the image sensor 300, to thus form N images of the scene on said image sensor, the N images being spatially offset from one another, as illustrated on FIG. 1. It should be noted that an additional image associated with the zero order diffraction of the bidimensional metasurface 220 can also be formed on the image sensor 300. Here the exit pupils 231 are located at the imaging optic 230.

FIG. 2A illustrates an example of an optical diagram of a polarimetric camera 100, similar to that of the invention, but which would not include angular filters 320 described below. In this example, the polarization separator 220 is a bidimensional metasurface.

A point A is placed in the object plane of the optical system 200, on the principal optical axis Δ. Light beams coming from the point A are collected by the collimation optic 210, which transmits them, collimated (parallel to each other and to the principal axis Δ), in the direction of the polarization separator 220.

The polarization separator 220 provides the diversion of the light beams according, here, to two different polarization states PS1 and PS2. It should be noted that the light beams associated with the zero order diffraction of the polarization separator 220 are not diverted. The light beams associated with the polarization states PS1 and PS2 are thus directed in the direction of the imaging optic 230 so as to be offset in pairs with respect to the principal optical axis Δ (above and below the principal optical axis Δ, according to the orientation in FIG. 2A), at a distance from the principal optical axis Δ. In this way an exit pupil 231_{PS1} associated with the state PS1, an exit pupil 231_{PS2} associated with the state PS2 and an exit pupil associated with the zero order diffraction are obtained. These exit pupils are offset in pairs orthogonally to the principal optical axis Δ, and therefore do not completely overlap.

The imaging optic 230 next focuses the incident light beams on the image plane of the optical system 200, in distinct zones of the image sensor 300, thus forming a plurality of distinct images. Thus, the image of the point A associated with the state PS1 is denoted A′_{PS1}, and the image of the point A associated with the state PS2 is denoted A′_{PS2}. The image of the point A associated with the zero order diffraction of the polarization separator 220 is also denoted A′_{DO0}. The optical axes associated with these three exit pupils are distinct from one another, and the three image points are also spatially distinct from one another. In this way two distinct images are obtained associated with the two polarization states PS1 and PS2, and an image associated with the zero order diffraction that is also distinct from the other two.

However, it can be seen that the image B′ of a point B on the scene, located outside the optical axis and not shown on FIGS. 2A and 2B, associated with the zero order diffraction, can be detected by the detection pixel that receives the image point A′_{PS1}. Likewise, the image B″ of another point on the scene, associated with the zero order diffraction, can be detected by the detection pixel that receives the image point A′_{PS2}. In addition, it is also possible for an image point associated with the polarization state PS2 to be detected by the subset of pixels associated with the polarization state PS1, and vice versa.

FIG. 2B illustrates an example of an optical diagram of a polarimetric camera 100 according to one embodiment, which includes angular filters 320. In this example also, the polarization separator 220 is a bidimensional metasurface.

As indicated above, at least N angular filters 320 are located between the optical system 200 and the photodetectors 303 of the image sensor 300. Each angular filter 320 is adapted to transmit, to a subset of pixels, the incident light beams coming from the associated exit pupil 231, and to at least partly filter the incident light beams coming from the other exit pupil or pupils 231.

Thus, as shown on the figure, the detection pixels associated with the exit pixel 231_{PS1} transmit the light beams having the polarization state PS1 but at least partly filter those associated with the polarization state PS2 like those associated with the zero order diffraction. Likewise, the detection pixels associated with the exit pixel 231_{PS2} transmit the light beams having the polarization state PS2 but at least partly filter those associated with the polarization state PS1 like those associated with the zero order diffraction.

In this way a polarimetric camera is obtained having improved performances, since the quality of the two images associated with the polarization states PS1 and PS2 are improved, through the fact of at least partly filtering the light beams that can be termed parasitic, i.e. those that are not associated with the required polarization state. In addition, associating the angular filters 320 with the polarization separator 220 makes it possible to use standard photodetectors.

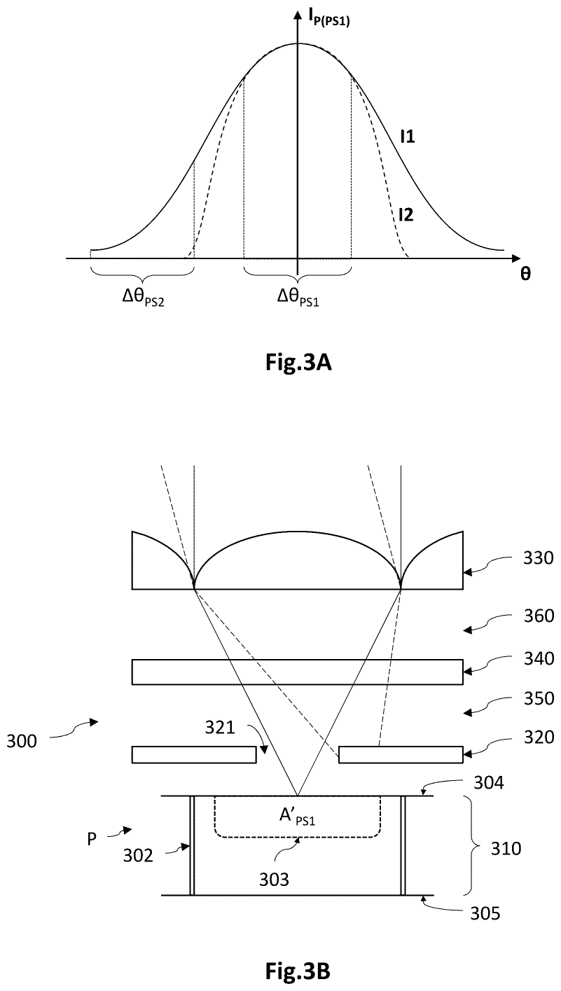

FIG. 3A illustrates an example of angular response of a detection pixel P of the image sensor 300 of the polarimetric camera 100 according to one embodiment. It is a case of the amplitude of the measurement signal of the detection pixel, for a given incident light flow, according to the angle of incidence of the light beams detected.

A detection pixel dedicated to the polarization state PS1 is considered here. Light beams associated with the polarization state PS2, which form parasitic beams, are liable to reach this detection pixel.

A continuous line shows the angular response of a detection pixel of a polarimetric camera similar to the one in FIG. 2A, i.e. without angular filter 320, and a broken line the angular response of a detection pixel of an polarimetric camera according to one embodiment of the invention, i.e. with angular filter 320.

The light beams associated with the polarization state PS1 are incident on the detection pixel in an angular cone denoted Δθ_{PS1}. The integral of the response I in the angular amplitude Δθ_{PS1} participates in forming the measurement signal.

However, it is noted that light beams associated with the polarization state PS2 are also incident on the detection pixel in an angular cone denoted Δθ_{PS2}. In the case of a polarimetric camera not including an angular filter 320, these light beams also participate in forming the measurement signal, which degrades the performances of the polarimetric camera.

On the other hand, the angular response of a detection pixel associated with an angular filter (broken line) shows a reduced sensitivity to the light beams located outside the angular amplitude Δθ_{PS1}. In other words, the angular filter makes it possible to filter the light beams that are not associated with the expected polarization state (and therefore which do not come from the exit pupil associated with the detection pixel). The performances of the polarimetric camera according to the invention are therefore improved.

Let us return to FIG. 1. The image sensor 300 is located in the image plane of the optical system 200. It comprises a plurality of detection pixels P. Each detection pixel P comprises a photodetector 303. As indicated previously, the detection pixels are grouped in subsets, each subset being associated with an exit pupil. There are therefore at least N subsets of detection pixels, for N exit pupils associated with the N polarization states. A subset of detection pixels, centred on the principal optical axis Δ, can be associated with the exit pupil related to the zero order diffraction of the polarization separator 220 (in the case of a bidimensional metasurface).

FIG. 3B is a schematic partial view, in cross section, of an image sensor 300 of our polarimetric camera according to one embodiment.

The photodetectors 303 of the detection pixels are formed in a semiconductor substrate 310. The semiconductor substrate 310 is produced for example from a monocrystalline semiconductor material, for example silicon.

Isolation trenches or walls 302, extending vertically in the semiconductor substrate 301, laterally separate, electrically and/or optically, the photodetectors 303 of the detection pixels from one another, so as to limit crosstalk. The isolation walls 302 are for example produced from a dielectric material, for example silicon oxide.

In the example in FIG. 3B, the image sensor 100 is a sensor for illumination from the rear face, also referred to as a BSI (“Back Side Illumination”) sensor, i.e. the light beams coming from the scene to be imaged illuminate the semiconductor substrate through one face, referred to as the rear face 304. The rear face 304 of the semiconductor substrate 310 of the image sensor is disposed in the image plane of the optical system 200.

The image sensor 300 furthermore comprises, on the same side as the front face 305, corresponding to the bottom face of the semiconductor substrate 101, a stack (not shown on the figures) of insulating and conductive layers (for example metal), commonly referred to as an interconnection stack, wherein elements interconnecting the detection pixels P of the image sensor 300 are formed.

It is clear that the embodiments described also apply to sensors for illumination through the front face or FSI (“Front Side Illumination”) sensor, i.e. sensors in which the semiconductor substrate is intended to be illuminated through its face in contact with the interconnection stack.

The detection pixels P of the image sensor 300 are preferentially arranged in a matrix in rows and columns, as illustrated on FIG. 1. The detection pixels P are preferentially all identical, to within manufacturing dispersions, or similar.

The detection pixels P of the image sensor are distributed in N subsets of pixels. Each subset of detection pixels P comprises a set of adjacent pixels. The N subsets of pixels are distinct from one another. Thus, each detection pixel P belongs to only one subset.

In the example in FIG. 1, the detection pixels P are distributed in four subsets of pixels. Each subset of detection pixels P is intended to receive incident light beams, coming from its associated exit pupil, according to one of the four polarization states PS1, PS2, PS3, PS4.

Moreover, the image sensor 300 furthermore includes N angular filters 320. They are located between the optical system 200 and the photodetectors 303. As indicated previously, each angular filter 320 is adapted to transmit, to a subset of pixels, the incident light beams coming from the associated exit pupil 231, and to at least partly filter the incident light beams coming from the other exit pupil or pupils 231.

Each angular filter 320 is therefore associated respectively with a subset of detection pixels and with the associated exit pupil 231. Thus, in the example of FIG. 1 where the polarization separator 220 provides the diversion of the light beams according to the four polarization states PS1, PS2, PS3 and PS4, the polarization state PS1 is associated with the exit pupil (denoted here 231_{PS1}) and then with the angular filter (denoted here 320_{PS1}) and with the subset of detection pixels (denoted here EP_{PS1}), the polarization state PS2 is associated with the exit pupil 231_{PS2} and then with the angular filter 320_{PS2} and with the subset EP_{PS2} of detection pixels, and so on.

In the example in FIG. 3B, the angular filters 320 are opaque structures comprising through openings 321, each through opening 321 being disposed facing the photodetectors 303 of a detection pixel P. The transverse dimensions of the through openings 321 are defined to allow the transmission of the light beams coming from the associated exit pupil and to at least partly filter those coming from other exit pupils.

By way of example, the opaque structures are produced from a material that is for example metallic, such as aluminium, copper or tungsten, among others. Preferably, the N angular filters are disposed so as to be coplanar. Preferably, the N angular filters 320 are produced in the same opaque structure. The opaque structure is for example a grid.

Thus, as shown by FIG. 3B, the light beams coming from the associated exit pupil (continuous lines) are transmitted by the angular filter 320, whereas those coming from the other exit pupils (broken lines) are at least partly filtered, and here completely filtered.

In one embodiment, the image sensor 300 can include a plurality of microlenses 330. The microlenses 330 preferably disposed between the optical system 200 and the angular filters 320. They provide a focusing of the incident light beams on the detection pixel associated with the microlens 330. In the case where the image sensor 300 does not include microlenses 330, it can include an angular filter similar to that of the filters 320 to fulfil an angular selection function similar to that of the microlenses 330.

In one example embodiment, but which is non-limitative, and as illustrated on FIG. 1, each microlens 330 extends, in dimension, facing a pixel. In other words, there are thus as many microlenses as there are pixels in the image sensor. It should be noted that the microlenses 330 can be offset transversely to the facing pixel to take account of the principal angle by which the light rays intended to be captured by this pixel arrive. The microlenses 330, the polarizing filters 340 and the through openings 321 of the angular filters 320 are then offset according to the value of this angle of incidence.

In one embodiment, as illustrated on FIG. 3B, the image sensor can include, apart from the N angular filters, N polarizing filters 340. The N polarizing filters 340 are here disposed between the microlenses 330 and the angular filters 320, but they could be located between the angular filters 320 and the photodetectors 303.

Each polarizing filter 340 is associated respectively with a subset of detection pixels and therefore with an exit pupil 231 of the optical system 200.

Each polarizing filter 340 is adapted to transmit the incident light rays in a predefined polarization state and to block the incident light rays in the other polarization states.

Thus, the image sensor 300 comprises N polarizing filters 340 each having different polarization orientations and are thus each adapted to transmit solely the incident light rays in a given polarization state, more particularly the incident light rays coming respectively from the associated exit pupil.

In a preferred embodiment, the polarizing filters 240 are metal structures comprising through openings and transmitting mainly the incident light beams in a predefined polarization state, i.e. the incident light beams coming solely from the associated exit pupil, and absorbing or reflecting the radiations in the other polarization states.

By way of non-limitative example, the metal structures of the polarizing filters are produced from aluminium, tungsten or copper. Preferably, the N polarizing filters are disposed so as to be coplanar. In one example embodiment, the N polarizing filters are produced in one and the same metal structure.

A filling layer 350 can be disposed between the angular filters 320 and the polarizing filters 340. Likewise, a filling layer 360 can be disposed between the polarizing filters 340 and the microlenses 330.

In a variant, the angular filters 320 and the polarizing filters 340 can be produced in the same layer: the opaque part of the layer 320 remains unchanged, and the polarizing filters 340 are located in the through openings 321.

The filling layer or layers 350, 360 can for example be produced from a dielectric material, transparent to the wavelengths to be detected, such as silicon oxide, silicon nitride, alumina, or tantalum oxide.

Likewise, the openings of the metal structures of the angular filters 320 and of the polarizing filters 340 can be filled by a dielectric material, transparent to the wavelengths to be detected, such as a silicon oxide, a silicon nitride, alumina, or a tantalum oxide, among others.

In a variant, the openings of the metal structures of the angular filters and of the polarizing filters can be left empty or filled with air.

The above description clearly illustrates that, through its various features and the advantage thereof, the present invention achieves the objectives set. In particular, the present invention proposes a polarimetric camera that makes it possible to block the parasitic incident light rays related to the overlapping of the images on the image sensor and those coming from the zero order generated by the polarization separator, when the latter is a bidimensional metasurface.

1. A polarimetric camera, including an optical system and an image sensor:
the optical system, having a principal optical axis, being adapted to form, on the image sensor, at least N spatially distinct images of a scene to be imaged, at the rate of one image per polarization state, with N greater than or equal to 2, N being a predefined number of polarization states, and including:
a polarization separator adapted to divert the incident light beams coming from the scene to be imaged according to the N polarization states, the optical system then having at least N exit pupils at least partly offset in pairs orthogonally to the principal optical axis;
the image sensor including a plurality of detection pixels each comprising a photodetector;
the detection pixels being distributed in at least N subsets of pixels, each associated with an exit pupil, and each intended to receive the incident light beams according to the polarization state of the associated exit pupil;
wherein the image sensor includes at least N angular filters located between the optical system and the photodetectors, each angular filter being adapted to transmit, to a subset of pixels, the incident light beams coming from the associated exit pupil, and to at least partly filter the incident light beams coming from the other exit pupil or pupils.

2. The polarimetric camera according to claim 1, wherein the pixels of a subset of pixels are adjacent.

3. The polarimetric camera according to claim 1, wherein the N angular filters are disposed so as to be coplanar.

4. The polarimetric camera according to claim 1, wherein the N angular filters are formed in one and the same grid having openings sized to transmit, to a subset of pixels, the incident light beams coming from the associated exit pupil, and to at least partly filter the incident light beams coming from the other exit pupil or pupils.

5. The polarimetric camera according to claim 4, wherein the grid is opaque.

6. The polarimetric camera according to claim 1, wherein the image sensor includes a plurality of microlenses, adapted to focus the incident light beams on the photodetectors of the detection pixels, and located between the optical system and the angular filters.

7. The polarimetric camera according to claim 1, wherein the polarization separator is a bidimensional metasurface.

8. The polarimetric camera according to claim 1, wherein the image sensor includes at least N polarizing filters located between the optical system and the angular filters, adapted to transmit, to a subset of pixels, the incident light beams coming from the associated exit pupil and having the associated polarization state, and to at least partly filter the incident light beams coming from the other exit pupils and therefore having other polarization states.

9. The polarimetric camera according to claim 8, wherein the N polarizing filters are disposed so as to be coplanar.

10. The polarimetric camera according to claim 8, wherein the N polarizing filters are produced in one and the same metal structure.
